(19) United States
(12) Patent Application Publication
(10) Pub. No.: US 2025/0146325 A1
(43) Pub. Date: May 8, 2025

(54) DETACHABLE LOCK DEVICE WITH COMBINATION LOCK

(71) Applicant: Dongguan City GeShengMei Industrial Co., Ltd, Dongguan (CN)

(72) Inventor: Taotao Lei, Dongguan (CN)

(21) Appl. No.: 19/015,578

(22) Filed: Jan. 9, 2025

(30) Foreign Application Priority Data
Nov. 7, 2024 (CN) 202422719088.4

(51) Int. Cl. E05B 37/12; E05B 65/52

(52) U.S. Cl. CPC E05B 37/12; E05B 65/52

(57) ABSTRACT

A detachable lock device with a combination lock includes a lower clamping plate, a locking assembly, a connecting assembly and an upper clamping plate. The upper clamping plate has a clamping position for clamping a zipper and an unclamping position for releasing the zipper, and the upper clamping plate is connected to the lower clamping plate through the connecting assembly, so that the upper clamping plate is locked at the clamping position relative to the lower clamping plate. The locking assembly has a rotatable encircling member, a locking area for locking a zipper slider, the zipper slider is locked in the locking area or the locking area is opened by rotating the encircling member, and the locking assembly includes a mechanical combination lock for locking or unlocking the encircling member. The detachable lock device has easy disassembly and assembly and simple structure.

### CROSS REFERENCE TO RELATED APPLICATIONS

The present application claims the benefit of Chinese Patent Application No. 2024227190884 filed on Nov. 7, 2024, the contents of which are incorporated herein by reference in their entirety.

### FIELD OF THE INVENTION

The present invention relates to the field of locks, particularly to a detachable lock device with a combination lock.

### BACKGROUND OF THE INVENTION

Zippers are common items in daily life, and they are used in a variety of applications such as suitcases, travel backpacks, school bags, handbags, portable tents, and mosquito nets. Most of these items do not come with locking mechanisms, which may lead to the theft, damage, malicious alteration, or exposure of personal belongings or important documents.

However, these items are generally not equipped with locks when purchased. There is commonly a need for the user to lock the zippers temporarily for safety, but it's obvious that the existing locks cannot meet their needs.

Therefore, there is an urgent need for a detachable lock device with a combination lock to address the aforementioned issues.

### SUMMARY OF THE INVENTION

A purpose of the present invention is to provide a detachable lock device with a combination lock which has easy disassembly and assembly and simple structure.

In order to achieve the purpose mentioned above, the present invention provides a detachable lock device with a combination lock including a lower clamping plate, a locking assembly, and a connecting assembly. A bottom of the locking assembly corresponding to the lower clamping plate is formed with an upper clamping plate, the upper clamping plate is located above the lower clamping plate, the upper clamping plate has a clamping position for clamping a zipper relative to the lower clamping plate and an unclamping position for releasing the zipper relative to the lower clamping plate, and the upper clamping plate is connected to the lower clamping plate through the connecting assembly, so that the upper clamping plate is locked at the clamping position relative to the lower clamping plate. The locking assembly has a rotatable encircling member, a locking area for locking a zipper slider is formed between the lower clamping plate and the encircling member, the zipper slider is locked in the locking area or the locking area is opened by rotating the encircling member, and the locking assembly includes a mechanical combination lock for locking or unlocking the encircling member.

Preferably, the lower clamping plate includes a main plate and a pressing toothed rack, the pressing toothed rack is arranged on a pressing surface of the main plate.

Preferably, the connecting assembly includes a threaded hole and a hand screw, the threaded hole is arranged on the upper clamping plate, the lower clamping plate has a locking hole, the hand screw passes through the locking hole and connects with the threaded hole, and the upper clamping plate is locked at the clamping position relative to the lower clamping plate.

Preferably, the locking assembly further includes a casing and a lock tongue, a bottom of the casing is formed with the upper clamping plate, the mechanical combination lock is built into the casing, an output end of the mechanical combination lock is matched with the lock tongue, the lock tongue is slidably arranged in the casing and has a locking position that engages with the encircling member and an unlocking position that disengages from the encircling member relative to the casing, and the lock tongue is switched between the locking position and the unlocking position under the driving of the mechanical combination lock.

Preferably, the mechanical combination lock includes a rotary dial combination lock and a sliding member, the sliding member is slidably arranged in the casing, the rotary dial combination lock is used to lock or unlock the sliding member, the sliding member is extended towards the lock tongue to form a sliding column, the lock tongue has a driving inclined surface corresponding to the sliding column, and the sliding column slides on the driving inclined surface, driving the lock tongue to switch between the locking position and the unlocking position.

Preferably, the casing has a rotating protrusion, the encircling member has a rotating hole corresponding to the rotating protrusion, the rotating protrusion is rotatably arranged in the rotating hole, and the encircling member has a cover.

Preferably, the encircling member has a mating hole, when the lock tongue is in the locking position, the lock tongue extends and engages with the mating hole, when the lock tongue is in the unlocking position, the lock tongue retracts and disengages from the mating hole.

Preferably, the encircling member includes a first rod, a second rod, and a third rod connected in sequence, the first rod is perpendicular to the second rod, the second rod is perpendicular to the third rod, a free end of the first rod and a free end of the third rod both are provided with the rotating hole, and a middle of the first rod is connected to the lock tongue.

Preferably, the locking assembly further includes an elastic member, the elastic member provides an elastic force which always tends to move the lock tongue from the unlocking position to the locking position.

Preferably, the lower clamping plate is extended outward to form a bottom support plate for accommodating a zipper slider.

Compared to the prior art, the detachable lock device with a combination lock of the present invention combines the lower clamping plate, the locking assembly, and the connecting assembly, and the bottom of the locking assembly corresponding to the lower clamping plate is formed with the upper clamping plate. The upper clamping plate is located above the lower clamping plate 1 and has a clamping position for clamping the zipper relative to the lower clamping plate, and an unclamping position for releasing the zipper. The upper clamping plate and the lower clamping plate are connected through the connecting assembly so that the upper clamping plate is locked at the clamping position relative to the lower clamping plate. By clamping between the upper and lower clamping plates, the detachable lock device of the present invention can be fixed on any device with a zipper. When in use, the user simply needs to open the zipper to be installed, place the detachable lock device at the end of the zipper, with the upper clamping plate and the lower clamping plate 1 positioned on the top and bottom sides of the zipper end, respectively. The upper clamping plate and the lower clamping plate are connected through the connecting assembly, so that the upper clamping plate is locked at the clamping position relative to the lower clamping plate. By clamping the sides of the zipper between the upper and lower clamping plates, the detachable lock device is fixed on the zipper, thus achieving a detachable connection between the lock and the zipper. The locking assembly has a rotatable encircling member. A locking area for locking the zipper slider is formed between the lower clamping plate 1 and the encircling member. The zipper slider can be locked in the locking area or the locking area is opened by rotating the encircling member. In other words, the locking or unlocking of the zipper slider is achieved by opening or closing the locking area. The locking assembly includes a mechanical combination lock, which is used to lock or unlock the locking state of the encircling member. The locking or unlocking of the encircling member is realized through the mechanical combination lock, which results in a simple structure.

### BRIEF DESCRIPTION OF THE DRAWINGS

FIG. 1 is a perspective view of the detachable lock device with a combination lock according to an embodiment of the present invention when connected with a zipper.

FIG. 2 is another perspective view of the detachable lock device with a combination lock according to an embodiment of the present invention when connected with a zipper.

FIG. 3 is a perspective view of the detachable lock device with a combination lock according to an embodiment of the present invention with the zipper hidden.

FIG. 4 is another perspective view of the detachable lock device with a combination lock according to an embodiment of the present invention with the zipper hidden.

FIG. 5 is an internal structure view of the detachable lock device with a combination lock according to an embodiment of the present invention.

FIG. 6 is an internal structure view of the detachable lock device with a combination lock according to an embodiment of the present invention.

FIG. 7 is an internal structure view of the detachable lock device with a combination lock according to an embodiment of the present invention.

FIG. 8 is a structural view of the encircling member of the detachable lock device with a combination lock according to an embodiment of the present invention.

### DETAILED DESCRIPTION OF ILLUSTRATED EMBODIMENTS

To provide a detailed explanation of the technical content, and structural features of the present invention, the following is further explained in conjunction with the implementation method and the accompanying drawings.

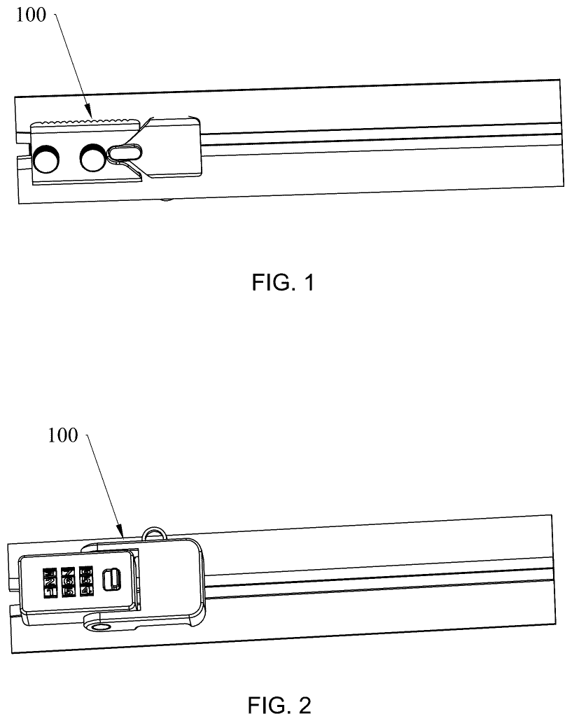

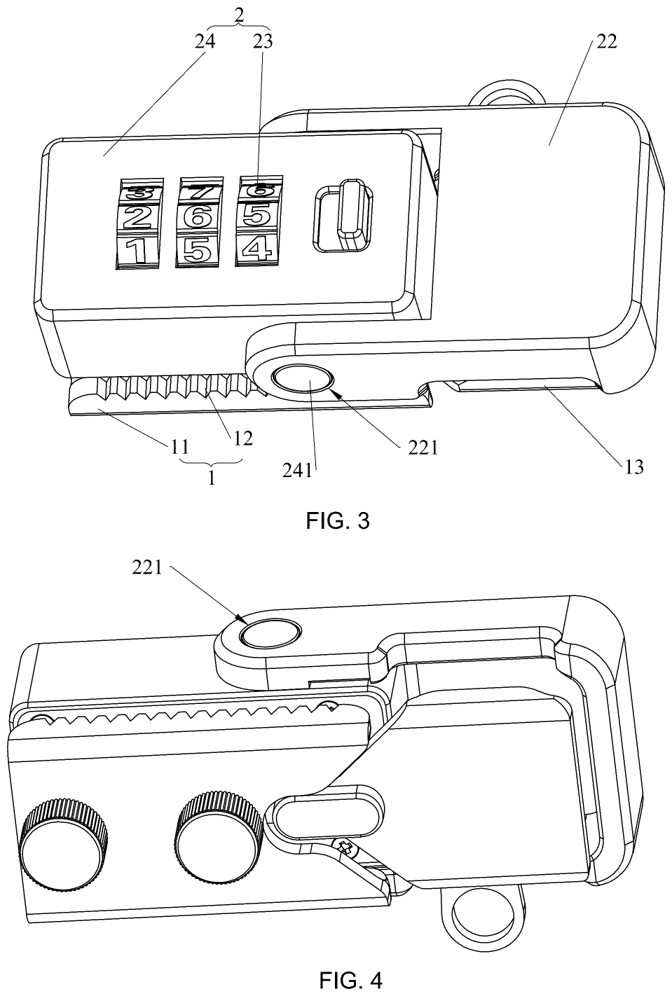

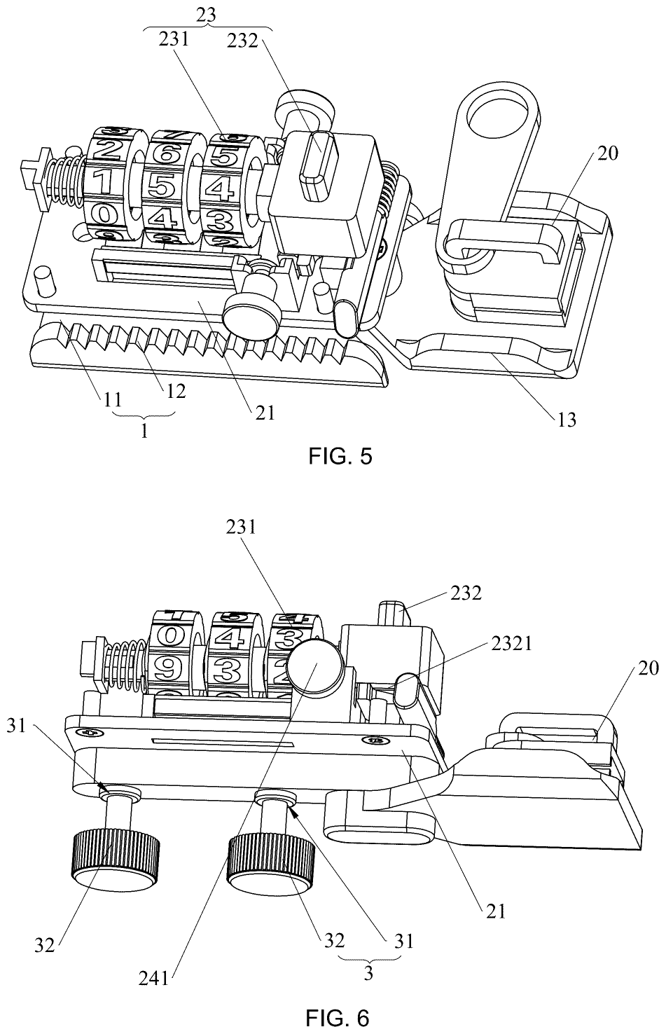

Referring to FIGS. 1 to 8, the detachable lock device with a combination lock 100 according to the present invention includes a lower clamping plate 1, a locking assembly 2, and a connecting assembly 3. The bottom of the locking assembly 2 corresponding to the lower clamping plate 1 is formed with an upper clamping plate 21. The upper clamping plate 21 is located above the lower clamping plate 1 and has a clamping position (as shown in FIGS. 1-2) for clamping a zipper relative to the lower clamping plate 1, and an unclamping position for releasing the zipper. The upper clamping plate 21 and the lower clamping plate 1 are connected through the connecting assembly 3 so that the upper clamping plate 21 is locked at the clamping position relative to the lower clamping plate 1. By clamping between the upper and lower clamping plates, the detachable lock device with a combination lock 100 can be fixed on any device with a zipper. When in use, the user simply needs to open the zipper to be installed, place the detachable lock device 100 at the end of the zipper, with the upper clamping plate 21 and the lower clamping plate 1 positioned on the top and bottom sides of the zipper end, respectively. The upper clamping plate 21 and the lower clamping plate 1 are connected through the connecting assembly 3, so that the upper clamping plate 21 is locked at the clamping position relative to the lower clamping plate 1. By clamping the sides of the zipper between the upper and lower clamping plates, the detachable lock device 100 is now fixed on the zipper, thus achieving a detachable connection between the lock 100 and the zipper. The locking assembly 2 has a rotatable encircling member 22. A locking area for locking the zipper slider 20 is formed between the lower clamping plate 1 and the encircling member 22. The zipper slider 20 can be locked in the locking area or the locking area can be opened by rotating the encircling member 22. In other words, the locking or unlocking of the zipper slider 20 is achieved by opening or closing the locking area. The locking assembly 2 includes a mechanical combination lock 23, which is used to lock or unlock the locked state of the encircling member 22. In such a way, the locking or unlocking of the encircling member 22 is realized through the mechanical combination lock 23, thereby resulting in a simple structure.

More specifically, referring to FIGS. 1 to 8, the lower clamping plate 1 includes a main plate 11 and a pressing toothed rack 12, which is arranged on the pressing surface of the main plate 11. The pressing toothed rack 12 is skidproof. Preferably, the pressing toothed racks 12 are symmetrically arranged on both sides of the main plate 11. For example, the connecting assembly 3 includes a threaded hole 31 and a hand screw 32. The threaded hole 31 is arranged on the upper clamping plate 21, and the lower clamping plate 1 has a locking hole (not shown). The hand screw 32 passes through the locking hole and connects with the threaded hole 31, so that the upper clamping plate 21 is locked at the clamping position relative to the lower clamping plate 1.

Referring to FIGS. 1 to 8, the locking assembly 2 further includes a casing 24, a lock tongue 25, and an elastic member 26. The bottom of the casing 24 is formed with the upper clamping plate 21. The mechanical combination lock 23 is built into the casing 24, and the output end of the mechanical combination lock 23 is matched with the lock tongue 25. The lock tongue 25 is slidably arranged in the casing 24 and has a locking position that engages with the encircling member 22 and an unlocking position that disengages from the encircling member 22 relative to the casing 24. The lock tongue 25 is switched between the locking position and the unlocking position under the drive of the mechanical combination lock 23. The locking assembly 2 further includes an elastic member 26, which provides an elastic force that always tends to move the lock tongue 25 from the unlocking position to the locking position.

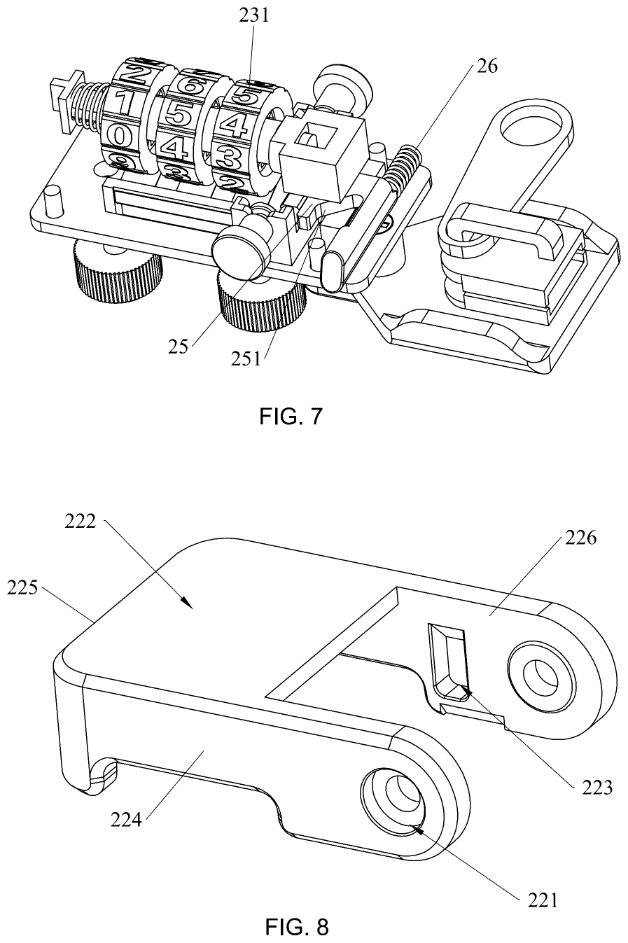

Referring to FIGS. 6 to 7, the mechanical combination lock 23 includes a rotary dial combination lock 231 and a sliding member 232. The sliding member 232 is slidably arranged in the casing 24. The rotary dial combination lock 231 is used to lock or unlock the sliding of the sliding member 232. The sliding member 232 is extended towards the lock tongue 25 to form a sliding column 2321. The lock tongue 25 has a driving inclined surface 251 corresponding to the sliding column 2321. The sliding column 2321 drives the lock tongue 25 to switch between the locking position and the unlocking position by sliding on the driving inclined surface 251. It can be understood that when the sliding member 232 is in the initial state, it does not act on the lock tongue 25. The lock tongue 25 moves from the unlocking position to the locking position under the elastic action of the elastic member 26. At this time, the rotary dial combination lock 231 locks the movement of the sliding member 232, the lock tongue 25 remains locked, and the encircling member 22 cannot rotate freely. When unlocking is needed, the rotary dial combination lock 231 unlocks the movement of the sliding member 232, accordingly, the sliding member 232 can move, and the movement of the sliding member 232 drives the sliding column 2321 to move. Therefore, the sliding column 2321 drives the lock tongue 25 to overcome the elastic force of the elastic member 26 and move from the locking position to the unlocking position by sliding on the driving inclined surface 251, and the encircling member 22 can rotate freely.

Referring to FIGS. 7 to 8, the encircling member 22 has a mating hole 223. When the lock tongue 25 is in the locking position, the lock tongue 25 extends and engages with the mating hole 223. When the lock tongue 25 is in the unlocking position, the lock tongue 25 retracts and disengages from the mating hole 223, thereby allowing the encircling member 22 to rotate freely.

Refer to FIGS. 1 to 8, the casing 24 has a rotating protrusion 241, and the encircling member 22 has a rotating hole 221 corresponding to the rotating protrusion 241. The rotating protrusion 241 is rotatably arranged in the rotating hole 221. The cooperation between the rotating protrusion 241 and the rotating hole 221 allows the encircling member 22 to move more smoothly. Specifically, the encircling member 22 has a cover 222, which can cover the zipper slider 20. The lower clamping plate 1 is extended outward to form a bottom support plate 13 for accommodating the zipper slider 20, thereby facilitating the zipper slider 20 to enter or exit.

Refer to FIG. 8, the encircling member 22 includes a first rod 224, a second rod 225, and a third rod 226 connected in sequence. The first rod 224 is perpendicular to the second rod 225, and the second rod 225 is perpendicular to the third rod 226. Both the free end of the first rod 224 and the free end of the third rod 226 have rotating holes 221. The middle of the first rod 224 is connected to the lock tongue 25.

Referring to FIGS. 1 to 8, the working process of the detachable lock device with a combination lock 100 of the present invention follows. When in use, the user simply needs to open the zipper to be installed, place the detachable lock device 100 at the end of the zipper, with the upper clamping plate 21 and the lower clamping plate 1 positioned on the top and bottom sides of the zipper end, respectively. The upper clamping plate 21 and the lower clamping plate 1 are connected through the connecting assembly 3, thus the upper clamping plate 21 is locked at the clamping position relative to the lower clamping plate 1. By clamping the sides of the zipper between the upper and lower clamping plates, the detachable lock device 100 is fixed on the zipper.

When the sliding member 232 is in its initial state, it does not exert any force on the lock tongue 25. Under the elastic force of the elastic member 26, the lock tongue 25 moves from the unlocked position to the locked position. At this time, the rotary dial combination lock 231 locks the movement of the sliding member 232, keeping the lock tongue 25 in the locked position and preventing the encircling member 22 from rotating freely. When unlocking is required, the rotary dial combination lock 231 releases the sliding member 232, allowing it to move. Accordingly, the movement of the sliding member 232 drives the sliding column 2321, and the sliding column 2321, in turn, drives the lock tongue 25 to overcome the elastic force of the elastic member 26 and move from the locked position to the unlocked position by sliding on the driving inclined surface 251. As a result, the encircling member 22 can then rotate freely, and the zipper slider 20 can freely enter or exit the locking area when the locking area is opened.

By combining the lower clamping plate 1, the locking assembly 2, and the connecting assembly 3, the bottom of the locking assembly 2 corresponding to the lower clamping plate 1 is formed with the upper clamping plate 21. The upper clamping plate 21 is located above the lower clamping plate 1 and has a clamping position for clamping the zipper relative to the lower clamping plate 1, and an unclamping position for releasing the zipper. The upper clamping plate 21 and the lower clamping plate 1 are connected through the connecting assembly 3 so that the upper clamping plate 21 is locked at the clamping position relative to the lower clamping plate 1. By clamping between the upper and lower clamping plates, the detachable lock device 100 of the present invention can be fixed on any device with a zipper. When in use, the user simply needs to open the zipper to be installed, place the detachable lock device 100 at the end of the zipper, with the upper clamping plate 21 and the lower clamping plate 1 positioned on the top and bottom sides of the zipper end, respectively. The upper clamping plate 21 and the lower clamping plate 1 are connected through the connecting assembly 3, so that the upper clamping plate 21 is locked at the clamping position relative to the lower clamping plate 1. By clamping the sides of the zipper between the upper and lower clamping plates 21 and 1, the detachable lock device 100 is now fixed on the zipper, thus achieving a detachable connection between the lock and the zipper. The locking assembly 2 has a rotatable encircling member 22. A locking area for locking the zipper slider 20 is formed between the lower clamping plate 1 and the encircling member 22. The zipper slider 20 can be locked in the locking area or the locking area is opened by rotating the encircling member 22. In other words, the locking or unlocking of the zipper slider 20 is achieved by opening or closing the locking area. The locking assembly 2 includes a mechanical combination lock 23, which is used to lock or unlock the locking state of the encircling member 22. The locking or unlocking of the encircling member 22 is realized through the mechanical combination lock 23, which results in a simple structure.

The above disclosure is only a preferred example of the present invention and cannot be used to limit the scope of rights of the present invention. Therefore, any equivalent changes made in accordance with the claims of the present invention are within the scope of the present invention.

What is claimed is:

1. A detachable lock device with a combination lock, comprising a lower clamping plate, a locking assembly, and a connecting assembly, wherein a bottom of the locking assembly corresponding to the lower clamping plate is formed with an upper clamping plate, the upper clamping plate is located above the lower clamping plate, the upper clamping plate has a clamping position for clamping a zipper relative to the lower clamping plate and an unclamping position for releasing the zipper relative to the lower clamping plate, and the upper clamping plate is connected to the lower clamping plate through the connecting assembly, so that the upper clamping plate is locked at the clamping position relative to the lower clamping plate; the locking assembly has a rotatable encircling member, a locking area for locking a zipper slider is formed between the lower clamping plate and the encircling member, by rotating the encircling member, the zipper slider is locked in the locking area or the locking area is opened, and the locking assembly comprises a mechanical combination lock for locking or unlocking the encircling member.

2. The detachable lock device with a combination lock according to claim 1, wherein the lower clamping plate comprises a main plate and a pressing toothed rack, the pressing toothed rack is arranged on a pressing surface of the main plate.

3. The detachable lock device with a combination lock according to claim 1, wherein the connecting assembly comprises a threaded hole and a hand screw, the threaded hole is arranged on the upper clamping plate, the lower clamping plate has a locking hole, the hand screw passes through the locking hole and connects with the threaded hole, and the upper clamping plate is locked at the clamping position relative to the lower clamping plate.

4. The detachable lock device with a combination lock according to claim 1, wherein the locking assembly further comprises a casing and a lock tongue, a bottom of the casing is formed with the upper clamping plate, the mechanical combination lock is built into the casing, an output end of the mechanical combination lock is matched with the lock tongue, the lock tongue is slidably arranged in the casing and has a locking position that engages with the encircling member and an unlocking position that disengages from the encircling member relative to the casing, and the lock tongue is switched between the locking position and the unlocking position under the driving of the mechanical combination lock.

5. The detachable lock device with a combination lock according to claim 4, wherein the mechanical combination lock comprises a rotary dial combination lock and a sliding member, the sliding member is slidably arranged in the casing, the rotary dial combination lock is used to lock or unlock the sliding member, the sliding member is extended towards the lock tongue to form a sliding column, the lock tongue has a driving inclined surface corresponding to the sliding column, and the sliding column slides on the driving inclined surface, driving the lock tongue to switch between the locking position and the unlocking position.

6. The detachable lock device with a combination lock according to claim 4, wherein the casing has a rotating protrusion, the encircling member has a rotating hole corresponding to the rotating protrusion, the rotating protrusion is rotatably arranged in the rotating hole, and the encircling member has a cover.

7. The detachable lock device with a combination lock according to claim 4, wherein the encircling member has a mating hole, when the lock tongue is in the locking position, the lock tongue extends and engages with the mating hole, when the lock tongue is in the unlocking position, the lock tongue retracts and disengages from the mating hole.

8. The detachable lock device with a combination lock according to claim 6, wherein the encircling member comprises a first rod, a second rod, and a third rod connected in sequence, the first rod is perpendicular to the second rod, the second rod is perpendicular to the third rod, a free end of the first rod and a free end of the third rod both are provided with the rotating hole, and a middle of the first rod is connected to the lock tongue.

9. The detachable lock device with a combination lock according to claim 5, wherein the locking assembly further comprises an elastic member, the elastic member provides an elastic force which always tends to move the lock tongue from the unlocking position to the locking position.

10. The detachable lock device with a combination lock according to claim 1, wherein the lower clamping plate is extended outward to form a bottom support plate for accommodating a zipper slider.
